(19) United States
(12) Patent Application Publication
(10) Pub. No.: US 2023/0198568 A1
(43) Pub. Date: Jun. 22, 2023

(54) ANTENNA SWITCHING SYSTEM

(71) Applicant: Intel Corporation, Santa Clara, CA (US)

(72) Inventors: Maruti Tamrakar, Bangalore (IN); Jayprakash Thakur, Bangalore (IN); Sagar Gupta, Ghaziabad (IN); Rajasekar Arumanayagam, TamilNadu (IN); Amarjeet Kumar, Bangalore (IN)

(21) Appl. No.: 17/559,843

(22) Filed: Dec. 22, 2021

(51) Int. Cl. H04B 1/44

(52) U.S. Cl. CPC H04B 1/44

(57) ABSTRACT

Embodiments of the present disclosure are directed to antenna switching systems. For example, some embodiments may include a switching system to allow a computing system to switch between an internal antenna and an external antenna. Other embodiments may be described and claimed.

### FIELD

Embodiments of the present invention relate generally to the technical field of antenna switching systems.

### BACKGROUND

Today, wireless technologies (e.g., Wi-Fi) are widely used to provide connectivity between a range of computing devices. In many such computing devices, namely mobile computing devices such as laptops, there are typically two Wi-Fi internal antennas coupled to the lid or base of the device. Most of these antennas function adequately when used with a device in a convertible or clamshell laptop mode, but the performance (efficiency) of the internal antennas tend to drop for devices in a closed lid mode, tablet mode and other use case scenarios. This drop in performance results in a corresponding drop in wireless throughput. Moreover, achieving good wireless performance using internal antennas is made more challenging for computing devices with relatively narrow bezel and thin system designs, independent of their use mode. Embodiments of the present disclosure address these and other issues.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1A and 1B illustrate an example of switching between internal and external antennas in accordance with various embodiments of the present disclosure.

FIGS. 2A and 2B illustrate an example of a radio frequency (RF) switching connector in accordance with various embodiments of the present disclosure.

FIG. 3 illustrates an example of an antenna switching system in a laptop form factor in accordance with various embodiments of the present disclosure.

FIG. 4 illustrates an example of a smart device, computer system, or a System-on-Chip (SoC) that may include one or more antenna switching systems described herein in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B). In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

As introduced above, achieving good wireless performance in computing devices using internal antennas can be very challenging for a variety of reasons. Internal antennas in computing devices pose a number of other potential issues as well. For example, in conventional systems when an internal antenna is damaged or not providing good performance, it typically needs replacement at a service center. This requires expertise to replace the antenna, may involve extra cost to user, and cannot work in a close lid/tablet mode use scenario.

In some embodiments, there are two Wi-Fi internal antennas are placed on LID or base, but a user faces a potential drop in wireless performance in different use cases like close lid/tablet modes or because of poor antenna performance when relying on the internal antennas alone.

Embodiments of the present disclosure help address the drawbacks of previous systems with internal antennas by providing a switching system to allow the usage of additional external antennas. For example, some embodiments may include systems with a passive RF switch connector to improve the Wi-Fi performance by auto-mechanical swapping between internal and external antennas. The external antenna connection can be used if the internal antenna shows poor performance or there is a need to boost the wireless performance of a computing device in different use cases.

Embodiments of the present disclosure help provide a number of advantages over current systems. For example, without opening the chassis or body of the user's computing device (e.g., a laptop's body), an end-user can disconnect an internal antenna and connect an external antenna simply by connecting the external antenna to an RF connector switch through a predefined opening to enhance the wireless connectivity of the user's device. This feature is also useful for developers for debug purposes. Furthermore, an external antenna may help to extend the wireless range and throughput of a computing device.

Embodiments of the present disclosure help provide a number of other advantages over conventional systems, including:
ease in restoring a wireless connection if a primary (internal) antenna gives poor connectivity;
boosting the wireless performance of a computing device in different use cases;
providing a better user experience compared to systems where the chassis/body of a user's computing device needs to be opened to service an internal antenna;
providing better performance in computing devices having full-metal chassis system in all modes;
helping to avoid radio frequency interference (RFI) or electromagnetic compatibility (EMC) issues due to system components with antennas that are external to the computing device; and
helping to provide enhanced system activity report (SAR) performance without power back-off requirements.

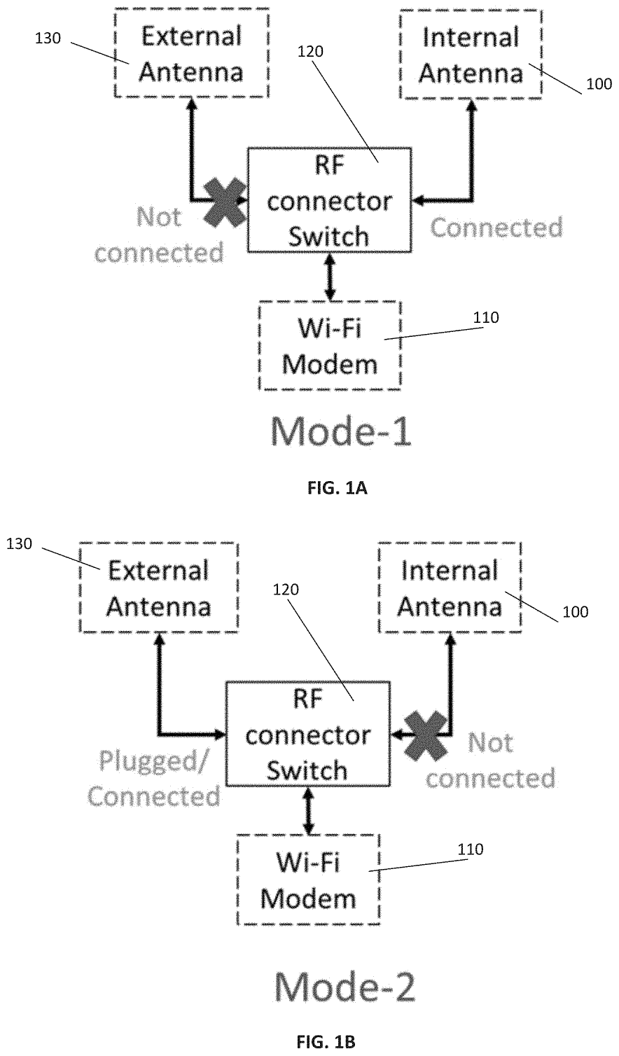

FIGS. 1A and 1B illustrate an example of utilizing additional/external antennas in a system with a passive RF switch connector to improve the Wi-Fi performance of a computing device by swapping between the antennas. In this example, the system includes an internal antenna 100, a wireless modem 110, and external antenna 130, and a radio frequency (RF) connector switch 120 coupled to the wireless modem 110 and the internal antenna 100. In the examples herein, a Wi-Fi modem is illustrated (e.g., operating between about 2.4 GHz and 6 GHz in various standards) but alternate embodiments may utilize a wireless modem that communicates using any suitable wireless communication protocol/frequency.

The RF connector switch 120 is adapted to receive a connector from an external antenna 130. As shown in FIG. 1A, when the connector of the external antenna 130 is not received by (or coupled to) the RF connector switch 120, the RF connector switch 120 connects the internal antenna 110 to the wireless modem in a first position (Mode-1). External antenna 130 is not connected to wireless modem 110 in this case.

As shown in FIG. 1B, the RF connector switch 120 is adapted to connect the external antenna 130 to the wireless modem 110 in a second position (Mode-2) when the connector from the external antenna 130 is received by (or coupled to) the RF connector switch 120. In this case, the internal antenna 100 is not connected to the wireless modem 110.

In this example, the external antenna 130 can be used if the internal antenna 100 shows poor performance, or there is a need to boost the wireless performance of the computing device in different use cases.

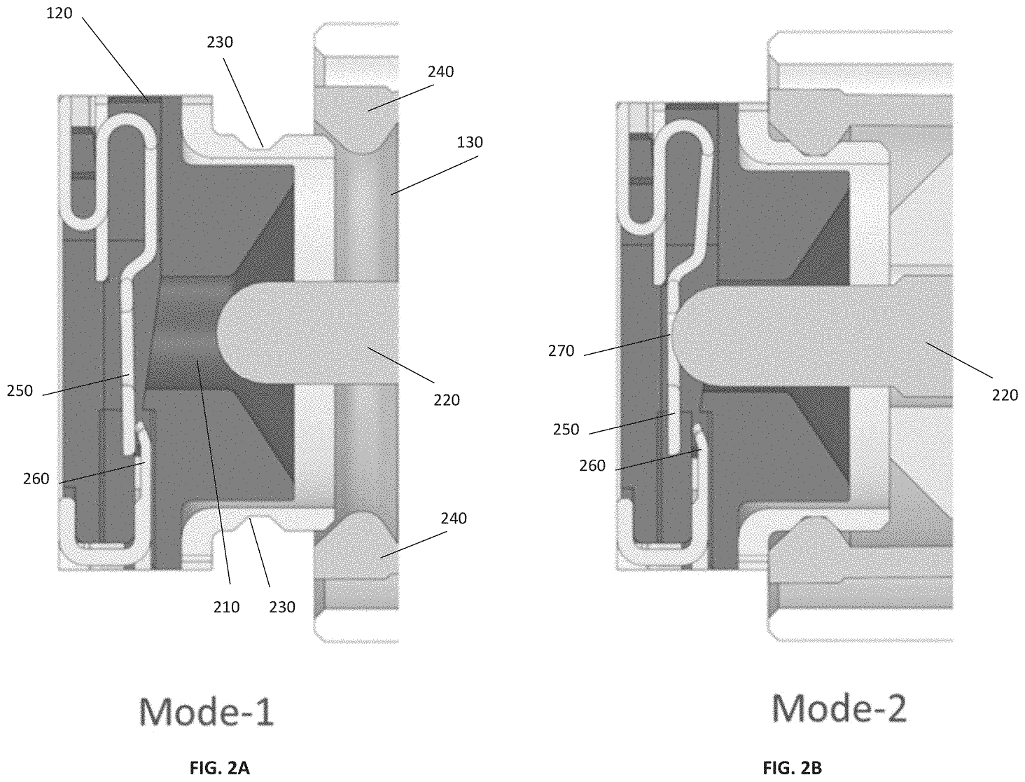

In some embodiments, the RF connector switch 120 can be activated by unmating (mode 1) and mating (mode 2) a plug of the external antenna 130 to the RF connector switch. FIGS. 2A and 2B illustrate a cutaway view of an example of an RF connector switch that may be utilized in conjunction with various embodiments, though other structures may be utilized with embodiments of this disclosure.

In the example shown in FIGS. 2A and 2B, the RF connector switch 120 includes a built-in mechanical switching apparatus to close a connection between the internal antenna 100 and the wireless modem 110 in the first position (Mode-1). The switching apparatus is further adapted to open the connection between the internal antenna 100 and the wireless modem 110, and close a connection between the external antenna 130 and the wireless modem 110, in the second position (Mode-2).

In the example shown in FIGS. 2A and 2B, RF connector switch 120 includes an opening 210 through which a connector 220 from the external antenna 130 is received. In some embodiments, the opening 210 is part of a pre-defined opening in the external chassis of a computing device through which the external antenna 130 can be removably attached to the RF connector switch 120.

The RF connector switch 120 includes a pair of recessed portions 230 that are adapted to receive clips 240 from the external antenna 130 to secure the external antenna 130 in place until released (e.g., by a user releasing clips 240). FIG. 2A illustrates the external antenna 130 partially received (but not yet connected) by RF connector switch 120, while FIG. 2B illustrates the external antenna 130 fully received by the RF connector switch 120.

In FIGS. 2A and 2B, the RF connector switch includes an example of a mechanical switching apparatus comprising a top portion 250 and a bottom portion 260. In alternate embodiments, other mechanisms may be utilized to mechanically switch connection of the wireless modem 110 between the internal antenna 100 and external antenna 130 in response to the external antenna 130 being received by the RF connector switch 120.

In FIG. 2A, when the connector 220 of the external antenna 130 is not fully inserted in opening 210, the top portion 250 and bottom portion 260 are engaged with each other to connect the internal antenna 100 to the wireless modem 110 in the first position of the RF connector switch 120 (Mode-1). In FIG. 2B, when the connector 220 of the external antenna 130 is received by the RF connector switch 120, the connector 220 of the external antenna 130 engages the top portion 250 of the mechanical switching apparatus at position 270, causing the top portion 250 to disengage from the bottom portion 260, and disconnecting the internal antenna 100 from the wireless modem 110 while connecting the external antenna 130 to the wireless modem 110.

In this manner, the RF switching apparatus provides a “two in one” solution for switching between two RF signal paths, namely between the internal antenna 100 and external antenna 130. Additionally, the mechanical switching apparatus helps minimize the size and cost of the RF connector switch 120. In some embodiments, for example, the length, width, and height of the RF connector switch are all less than 5 mm, thus providing a switch with a relatively small volume which allows it to be easily integrated into the form factors of a wide variety of computing devices.

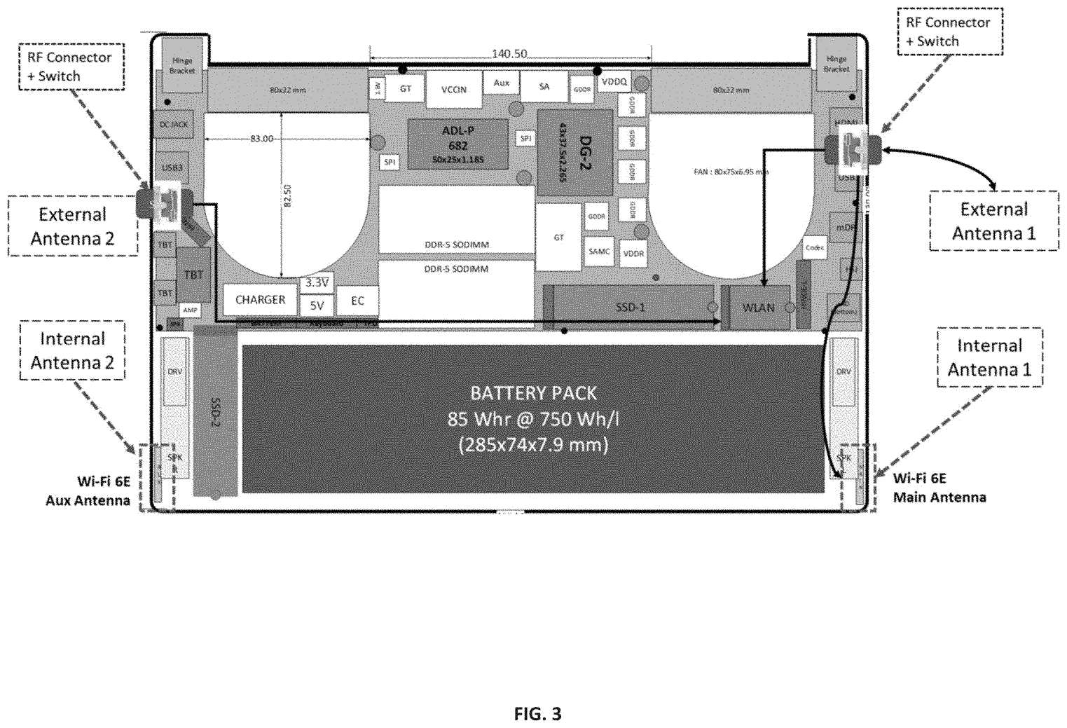

Embodiments of the present disclosure may be utilized to switch between any suitable number and type of internal and external antennas. For example, FIG. 3 illustrates an example of a pair of RF connector switches in conjunction with a laptop base. In some embodiments, one or more internal antennas may be additionally or alternatively coupled to the lid of the laptop. In the example shown in FIG. 3, a first RF connector switch receives external antenna 1, while a second RF connector switch receives external antenna 2. As described above, when a respective external antenna is plugged in to its respective RF connector switch, the switch automatically disconnects the RF path from the respective internal antenna to the WLAN modem. Otherwise, the respective RF connector switch connects its respective internal antenna to the WLAN modem. In this manner, the switching implementation can leverage to both the “Main” and “Aux” antenna depending upon the system architecture. As noted above, an external antenna in conjunction with a switching connector can be used for debug purposes, such as relative testing for RFI interference and other system certifications.

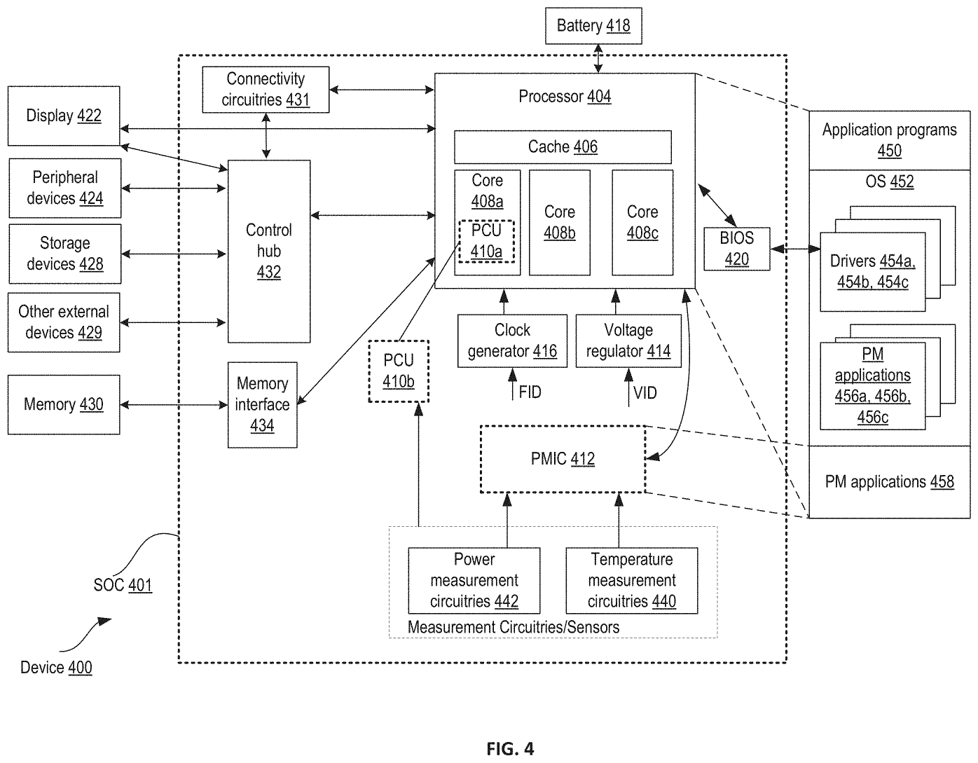

FIG. 4 illustrates a system (e.g., a smart device or a computer system or a System-on-Chip (SoC)), that may include an RF connector switch described herein (e.g., as one of peripheral devices 424) in accordance with some embodiments.

In some embodiments, device 400 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 400. The apparatus and/or software for controlling wake sources in a system to reduce power consumption in sleep state can be in the wireless connectivity circuitries 431, PCU 410, and/or other logic blocks (e.g., operating system 452) that can manage power for the computer system.

In an example, the device 400 comprises an SoC (System-on-Chip) 401. An example boundary of the SoC 401 is illustrated using dotted lines in FIG. 4, with some example components being illustrated to be included within SoC 401—however, SoC 401 may include any appropriate components of device 400.

In some embodiments, device 400 includes processor 404. Processor 404 can include one or more physical devices, such as microprocessors, application processors, microcontrollers, programmable logic devices, processing cores, or other processing means. The processing operations performed by processor 404 include the execution of an operating platform or operating system on which applications and/or device functions are executed. The processing operations include operations related to I/O (input/output) with a human user or with other devices, operations related to power management, operations related to connecting computing device 400 to another device, and/or the like. The processing operations may also include operations related to audio I/O and/or display I/O.

In some embodiments, processor 404 includes multiple processing cores (also referred to as cores) 408a, 408b, 408c. Although merely three cores 408a, 408b, 408c are illustrated in FIG. 4, processor 404 may include any other appropriate number of processing cores, e.g., tens, or even hundreds of processing cores. Processor cores 408a, 408b, 408c may be implemented on a single integrated circuit (IC) chip. Moreover, the chip may include one or more shared and/or private caches, buses or interconnections, graphics and/or memory controllers, or other components.

In some embodiments, processor 404 includes cache 406. In an example, sections of cache 406 may be dedicated to individual cores 408 (e.g., a first section of cache 406 dedicated to core 408a, a second section of cache 406 dedicated to core 408b, and so on). In an example, one or more sections of cache 406 may be shared among two or more of cores 408. Cache 406 may be split in different levels, e.g., level 1 (L1) cache, level 2 (L2) cache, level 3 (L3) cache, etc.

In some embodiments, processor core 404 may include a fetch unit to fetch instructions (including instructions with conditional branches) for execution by the core 404. The instructions may be fetched from any storage devices such as the memory 430. Processor core 404 may also include a decode unit to decode the fetched instruction. For example, the decode unit may decode the fetched instruction into a plurality of micro-operations. Processor core 404 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 404 may be an out-of-order processor core in one embodiment. Processor core 404 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 404 may also include a bus unit to enable communication between components of processor core 404 and other components via one or more buses. Processor core 404 may also include one or more registers to store data accessed by various components of the core 404 (such as values related to assigned app priorities and/or sub-system states (modes) association.

In some embodiments, device 400 comprises connectivity circuitries 431. For example, connectivity circuitries 431 includes hardware devices (e.g., wireless and/or wired connectors and communication hardware) and/or software components (e.g., drivers, protocol stacks), e.g., to enable device 400 to communicate with external devices. Device 400 may be separate from the external devices, such as other computing devices, wireless access points or base stations, etc.

In an example, connectivity circuitries 431 may include multiple different types of connectivity. To generalize, the connectivity circuitries 431 may include cellular connectivity circuitries, wireless connectivity circuitries, etc. Cellular connectivity circuitries of connectivity circuitries 431 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 431 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 431 may include a network interface, such as a wired or wireless interface, e.g., so that a system embodiment may be incorporated into a wireless device, for example, a cell phone or personal digital assistant.

In some embodiments, device 400 comprises control hub 432, which represents hardware devices and/or software components related to interaction with one or more I/O devices. For example, processor 404 may communicate with one or more of display 422, one or more peripheral devices 424, storage devices 428, one or more other external devices 429, etc., via control hub 432. Control hub 432 may be a chipset, a Platform Control Hub (PCH), and/or the like.

For example, control hub 432 illustrates one or more connection points for additional devices that connect to device 400, e.g., through which a user might interact with the system. For example, devices (e.g., devices 429) that can be attached to device 400 include microphone devices, speaker or stereo systems, audio devices, video systems or other display devices, keyboard or keypad devices, or other I/O devices for use with specific applications such as card readers or other devices.

As mentioned above, control hub 432 can interact with audio devices, display 422, etc. For example, input through a microphone or other audio device can provide input or commands for one or more applications or functions of device 400. Additionally, audio output can be provided instead of, or in addition to display output. In another example, if display 422 includes a touch screen, display 422 also acts as an input device, which can be at least partially managed by control hub 432. There can also be additional buttons or switches on computing device 400 to provide I/O functions managed by control hub 432. In one embodiment, control hub 432 manages devices such as accelerometers, cameras, light sensors or other environmental sensors, or other hardware that can be included in device 400. The input can be part of direct user interaction, as well as providing environmental input to the system to influence its operations (such as filtering for noise, adjusting displays for brightness detection, applying a flash for a camera, or other features).

In some embodiments, control hub 432 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 422 represents hardware (e.g., display devices) and software (e.g., drivers) components that provide a visual and/or tactile display for a user to interact with device 400. Display 422 may include a display interface, a display screen, and/or hardware device used to provide a display to a user. In some embodiments, display 422 includes a touch screen (or touch pad) device that provides both output and input to a user. In an example, display 422 may communicate directly with the processor 404. Display 422 can be one or more of an internal display device, as in a mobile electronic device or a laptop device or an external display device attached via a display interface (e.g., DisplayPort, etc.). In one embodiment display 422 can be a head mounted display (HMD) such as a stereoscopic display device for use in virtual reality (VR) applications or augmented reality (AR) applications.

In some embodiments, and although not illustrated in the figure, in addition to (or instead of) processor 404, device 400 may include Graphics Processing Unit (GPU) comprising one or more graphics processing cores, which may control one or more aspects of displaying contents on display 422.

Control hub 432 (or platform controller hub) may include hardware interfaces and connectors, as well as software components (e.g., drivers, protocol stacks) to make peripheral connections, e.g., to peripheral devices 424.

It will be understood that device 400 could both be a peripheral device to other computing devices, as well as have peripheral devices connected to it. Device 400 may have a “docking” connector to connect to other computing devices for purposes such as managing (e.g., downloading and/or uploading, changing, synchronizing) content on device 400. Additionally, a docking connector can allow device 400 to connect to certain peripherals that allow computing device 400 to control content output, for example, to audiovisual or other systems.

In addition to a proprietary docking connector or other proprietary connection hardware, device 400 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 431 may be coupled to control hub 432, e.g., in addition to, or instead of, being coupled directly to the processor 404. In some embodiments, display 422 may be coupled to control hub 432, e.g., in addition to, or instead of, being coupled directly to processor 404.

In some embodiments, device 400 comprises memory 430 coupled to processor 404 via memory interface 434. Memory 430 includes memory devices for storing information in device 400.

In some embodiments, memory 430 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 430 can be a dynamic random-access memory (DRAM) device, a static random-access memory (SRAM) device, flash memory device, phase-change memory device, or some other memory device having suitable performance to serve as process memory. In one embodiment, memory 430 can operate as system memory for device 400, to store data and instructions for use when the one or more processors 404 executes an application or process. Memory 430 can store application data, user data, music, photos, documents, or other data, as well as system data (whether long-term or temporary) related to the execution of the applications and functions of device 400.

Elements of various embodiments and examples are also provided as a machine-readable medium (e.g., memory 430) for storing the computer-executable instructions (e.g., instructions to implement any other processes discussed herein). The machine-readable medium (e.g., memory 430) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 400 comprises temperature measurement circuitries 440, e.g., for measuring temperature of various components of device 400. In an example, temperature measurement circuitries 440 may be embedded, or coupled or attached to various components, whose temperature are to be measured and monitored. For example, temperature measurement circuitries 440 may measure temperature of (or within) one or more of cores 408a, 408b, 408c, voltage regulator 414, memory 430, a mother-board of SoC 401, and/or any appropriate component of device 400.

In some embodiments, device 400 comprises power measurement circuitries 442, e.g., for measuring power consumed by one or more components of the device 400. In an example, in addition to, or instead of, measuring power, the power measurement circuitries 442 may measure voltage and/or current. In an example, the power measurement circuitries 442 may be embedded, or coupled or attached to various components, whose power, voltage, and/or current consumption are to be measured and monitored. For example, power measurement circuitries 442 may measure power, current and/or voltage supplied by one or more voltage regulators 414, power supplied to SoC 401, power supplied to device 400, power consumed by processor 404 (or any other component) of device 400, etc.

In some embodiments, device 400 comprises one or more voltage regulator circuitries, generally referred to as voltage regulator (VR) 414. VR 414 generates signals at appropriate voltage levels, which may be supplied to operate any appropriate components of the device 400. Merely as an example, VR 414 is illustrated to be supplying signals to processor 404 of device 400. In some embodiments, VR 414 receives one or more Voltage Identification (VID) signals, and generates the voltage signal at an appropriate level, based on the VID signals. Various type of VRs may be utilized for the VR 414. For example, VR 414 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 410a/b and/or PMIC 412. In some embodiments, each core has a network of distributed LDOs to provide efficient control for power management. The LDOs can be digital, analog, or a combination of digital or analog LDOs. In some embodiments, VR 414 includes current tracking apparatus to measure current through power supply rail(s).

In some embodiments, device 400 comprises one or more clock generator circuitries, generally referred to as clock generator 416. Clock generator 416 generates clock signals at appropriate frequency levels, which may be supplied to any appropriate components of device 400. Merely as an example, clock generator 416 is illustrated to be supplying clock signals to processor 404 of device 400. In some embodiments, clock generator 416 receives one or more Frequency Identification (FID) signals, and generates the clock signals at an appropriate frequency, based on the FID signals.

In some embodiments, device 400 comprises battery 418 supplying power to various components of device 400. Merely as an example, battery 418 is illustrated to be supplying power to processor 404. Although not illustrated in the figures, device 400 may comprise a charging circuitry, e.g., to recharge the battery, based on Alternating Current (AC) power supply received from an AC adapter.

In some embodiments, device 400 comprises Power Control Unit (PCU) 410 (also referred to as Power Management Unit (PMU), Power Controller, etc.). In an example, some sections of PCU 410 may be implemented by one or more processing cores 408, and these sections of PCU 410 are symbolically illustrated using a dotted box and labelled PCU 410a. In an example, some other sections of PCU 410 may be implemented outside the processing cores 408, and these sections of PCU 410 are symbolically illustrated using a dotted box and labelled as PCU 410b. PCU 410 may implement various power management operations for device 400. PCU 410 may include hardware interfaces, hardware circuitries, connectors, registers, etc., as well as software components (e.g., drivers, protocol stacks), to implement various power management operations for device 400.

In some embodiments, device 400 comprises Power Management Integrated Circuit (PMIC) 412, e.g., to implement various power management operations for device 400. In some embodiments, PMIC 412 is a Reconfigurable Power Management ICs (RPMICs) and/or an IMVP (Intel® Mobile Voltage Positioning). In an example, the PMIC is within an IC chip separate from processor 404. The may implement various power management operations for device 400. PMIC 412 may include hardware interfaces, hardware circuitries, connectors, registers, etc., as well as software components (e.g., drivers, protocol stacks), to implement various power management operations for device 400.

In an example, device 400 comprises one or both PCU 410 or PMIC 412. In an example, any one of PCU 410 or PMIC 412 may be absent in device 400, and hence, these components are illustrated using dotted lines.

Various power management operations of device 400 may be performed by PCU 410, by PMIC 412, or by a combination of PCU 410 and PMIC 412. For example, PCU 410 and/or PMIC 412 may select a power state (e.g., P-state) for various components of device 400. For example, PCU 410 and/or PMIC 412 may select a power state (e.g., in accordance with the ACPI (Advanced Configuration and Power Interface) specification) for various components of device 400. Merely as an example, PCU 410 and/or PMIC 412 may cause various components of the device 400 to transition to a sleep state, to an active state, to an appropriate C state (e.g., CO state, or another appropriate C state, in accordance with the ACPI specification), etc. In an example, PCU 410 and/or PMIC 412 may control a voltage output by VR 414 and/or a frequency of a clock signal output by the clock generator, e.g., by outputting the VID signal and/or the FID signal, respectively. In an example, PCU 410 and/or PMIC 412 may control battery power usage, charging of battery 418, and features related to power saving operation.

The clock generator 416 can comprise a phase locked loop (PLL), frequency locked loop (FLL), or any suitable clock source. In some embodiments, each core of processor 404 has its own clock source. As such, each core can operate at a frequency independent of the frequency of operation of the other core. In some embodiments, PCU 410 and/or PMIC 412 performs adaptive or dynamic frequency scaling or adjustment. For example, clock frequency of a processor core can be increased if the core is not operating at its maximum power consumption threshold or limit. In some embodiments, PCU 410 and/or PMIC 412 determines the operating condition of each core of a processor, and opportunistically adjusts frequency and/or power supply voltage of that core without the core clocking source (e.g., PLL of that core) losing lock when the PCU 410 and/or PMIC 412 determines that the core is operating below a target performance level. For example, if a core is drawing current from a power supply rail less than a total current allocated for that core or processor 404, then PCU 410 and/or PMIC 412 can temporality increase the power draw for that core or processor 404 (e.g., by increasing clock frequency and/or power supply voltage level) so that the core or processor 404 can perform at higher performance level. As such, voltage and/or frequency can be increased temporality for processor 404 without violating product reliability.

In an example, PCU 410 and/or PMIC 412 may perform power management operations, e.g., based at least in part on receiving measurements from power measurement circuitries 442, temperature measurement circuitries 440, charge level of battery 418, and/or any other appropriate information that may be used for power management. To that end, PMIC 412 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 410 and/or PMIC 412 in at least one embodiment to allow PCU 410 and/or PMIC 412 to manage processor core energy at least in part based on value(s) detected by one or more of the sensors.

Also illustrated is an example software stack of device 400 (although not all elements of the software stack are illustrated). Merely as an example, processors 404 may execute application programs 450, Operating System 452, one or more Power Management (PM) specific application programs (e.g., generically referred to as PM applications 458), and/or the like. PM applications 458 may also be executed by the PCU 410 and/or PMIC 412. OS 452 may also include one or more PM applications 456a, 456b, 456c. The OS 452 may also include various drivers 454a, 454b, 454c, etc., some of which may be specific for power management purposes. In some embodiments, device 400 may further comprise a Basic Input/output System (BIOS) 420. BIOS 420 may communicate with OS 452 (e.g., via one or more drivers 454), communicate with processors 404, etc.

For example, one or more of PM applications 458, 456, drivers 454, BIOS 420, etc. may be used to implement power management specific tasks, e.g., to control voltage and/or frequency of various components of device 400, to control wake-up state, sleep state, and/or any other appropriate power state of various components of device 400, control battery power usage, charging of the battery 418, features related to power saving operation, etc.

### Examples

Some non-limiting Examples of various embodiments are presented below.

Example 1 includes an apparatus comprising: an internal antenna; a wireless modem; and a radio frequency (RF) connector switch coupled to the wireless modem and the internal antenna, wherein the RF connector switch is adapted to receive a connector from an external antenna, and wherein the RF connector switch is adapted to: connect the internal antenna to the wireless modem in a first position when the connector from the external antenna is not received by the RF connector switch; and connect the external antenna to the wireless modem in a second position when the connector from the external antenna is received by the RF connector switch.

Example 2 includes the apparatus of example 1 or some other example herein, wherein the RF connector switch includes a mechanical switching apparatus that is to close a connection between the internal antenna and the wireless modem in the first position.

Example 3 includes the apparatus of example 2 or some other example herein, wherein the mechanical switching apparatus is adapted to open the connection between the internal antenna and the wireless modem, and close a connection between the external antenna and the wireless modem, in the second position.

Example 4 includes the apparatus of example 1 or some other example herein, wherein the connector from the external antenna is adapted to engage at least a portion of the mechanical switching apparatus to change the RF connector switch from the first position to the second position.

Example 5 includes the apparatus of example 1 or some other example herein, wherein the wireless modem is adapted to operate in a frequency between about 2.4 GHz and about 6 GHz.

Example 6 includes the apparatus of example 1 or some other example herein, wherein the RF switching connector has a volume defined by a length, a width, and a height, and wherein each of the length, width, and height of the RF switching connector are less than 5 mm.

Example 7 includes the apparatus of example 1 or some other example herein, wherein the apparatus comprises an external chassis, and wherein the external antenna is removably attachable to the RF connector switch through a pre-defined opening in the external chassis.

Example 8 includes the apparatus of example 1 or some other example herein, further comprising the external antenna coupled to the RF connector switch.

Example 9 includes an apparatus comprising: a first internal antenna; a second internal antenna; a wireless modem; a first radio frequency (RF) connector switch coupled to the wireless modem and the first internal antenna, wherein the first RF connector switch is adapted to receive a connector from a first external antenna, and wherein the first RF connector switch is adapted to: connect the first internal antenna to the wireless modem in a first position when the connector from the first external antenna is not received by the first RF connector switch; and connect the first external antenna to the wireless modem in a second position when the connector from the first external antenna is received by the RF connector switch; and a second RF connector switch coupled to the wireless modem and the second internal antenna, wherein the second RF connector switch is adapted to receive a connector from a second external antenna, and wherein the second RF connector switch is adapted to: connect the second internal antenna to the wireless modem in a first position when the connector from the second external antenna is not received by the second RF connector switch; and connect the second external antenna to the wireless modem in a second position when the connector from the second external antenna is received by the RF connector switch.

Example 10 includes the apparatus of example 9 or some other example herein, wherein the first RF connector switch includes a mechanical switching apparatus that is adapted to: close a connection between the first internal antenna and the wireless modem in the first position of the first RF connector switch; and open the connection between the first internal antenna and the wireless modem, and close a connection between the first external antennal and the wireless modem, in the second position of the first RF connector switch.

Example 11 includes the apparatus of example 9 or some other example herein, wherein the second RF connector switch includes a mechanical switching apparatus that is adapted to: close a connection between the second internal antenna and the wireless modem in the first position of the second RF connector switch; and open the connection between the second internal antenna and the wireless modem, and closes a connection between the second external antennal and the wireless modem, in the second position of the second RF connector switch.

Example 12 includes the apparatus of example 9 or some other example herein, wherein the connector from the first external antenna engages at least a portion of the mechanical switching apparatus to change the first RF connector switch from the first position to the second position.

Example 13 includes the apparatus of example 9 or some other example herein, wherein the wireless modem is operates in a frequency between about 2.4 GHz and about 6 GHz.

Example 14 includes the apparatus of example 9 or some other example herein, wherein the first RF switching connector and second RF switching connector each have a respective volume defined by a length, a width, and a height, and wherein each of the length, width, and height of both the first RF switching connector and second RF switching container are less than 5 mm.

Example 15 includes the apparatus of example 9 or some other example herein, wherein the apparatus comprises an external chassis, and wherein the first external antenna is removably attachable to the first RF connector switch through a first pre-defined opening in the external chassis, and the second external antenna is removably attachable to the second RF connector switch through a second pre-defined opening in the external chassis.

Example 16 includes the apparatus of example 9 or some other example herein, further comprising the first external antenna coupled to the first RF connector switch.

Example 17 includes a computer system comprising: a base comprising a keyboard; a lid coupled to the base and comprising a display screen; a first internal antenna coupled to the lid or the base; a second internal antenna coupled to the lid or the base; a wireless modem; a first radio frequency (RF) connector switch coupled to the wireless modem and the first internal antenna, wherein the first RF connector switch is adapted to receive a connector from a first external antenna, and wherein the first RF connector switch is adapted to: connect the first internal antenna to the wireless modem in a first position when the connector from the first external antenna is not received by the first RF connector switch; and connect the first external antenna to the wireless modem in a second position when the connector from the first external antenna is received by the RF connector switch; and a second RF connector switch coupled to the wireless modem and the second internal antenna, wherein the second RF connector switch is adapted to receive a connector from a second external antenna, and wherein the second RF connector switch is adapted to: connect the second internal antenna to the wireless modem in a first position when the connector from the second external antenna is not received by the second RF connector switch; and connect the second external antenna to the wireless modem in a second position when the connector from the second external antenna is received by the RF connector switch.

Example 18 includes the computer system of example 17 or some other example herein, wherein the first RF connector switch includes a mechanical switching apparatus that is adapted to: close a connection between the first internal antenna and the wireless modem in the first position of the first RF connector switch; and open the connection between the first internal antenna and the wireless modem, and close a connection between the first external antennal and the wireless modem, in the second position of the first RF connector switch.

Example 19 includes the computer system of example 17 or some other example herein, wherein the second RF connector switch includes a mechanical switching apparatus that is adapted to: close a connection between the second internal antenna and the wireless modem in the first position of the second RF connector switch; and open the connection between the second internal antenna and the wireless modem, and closes a connection between the second external antennal and the wireless modem, in the second position of the second RF connector switch.

Example 20 includes the computer system of example 17 or some other example herein, wherein the connector from the first external antenna engages at least a portion of the mechanical switching apparatus to change the first RF connector switch from the first position to the second position.

Example 21 includes the computer system of example 17 or some other example herein, wherein the wireless modem is operates in a frequency between about 2.4 GHz and about 6 GHz.

Example 22 includes the computer system of example 17 or some other example herein, wherein the first RF switching connector and second RF switching connector each have a respective volume defined by a length, a width, and a height, and wherein each of the length, width, and height of both the first RF switching connector and second RF switching container are less than 5 mm.

Example 23 includes the computer system of example 17 or some other example herein, wherein the apparatus comprises an external chassis, and wherein the first external antenna is removably attachable to the first RF connector switch through a first pre-defined opening in the external chassis, and the second external antenna is removably attachable to the second RF connector switch through a second pre-defined opening in the external chassis.

Example 24 includes the computer system of example 17 or some other example herein, further comprising the first external antenna coupled to the first RF connector switch.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

What is claimed is:

1. An apparatus comprising:
an internal antenna;
a wireless modem; and
a radio frequency (RF) connector switch coupled to the wireless modem and the internal antenna, wherein the RF connector switch is adapted to receive a connector from an external antenna, and wherein the RF connector switch is adapted to:
connect the internal antenna to the wireless modem in a first position when the connector from the external antenna is not received by the RF connector switch; and
connect the external antenna to the wireless modem in a second position when the connector from the external antenna is received by the RF connector switch.

2. The apparatus of claim 1, wherein the RF connector switch includes a mechanical switching apparatus that is to close a connection between the internal antenna and the wireless modem in the first position.

3. The apparatus of claim 2, wherein the mechanical switching apparatus is adapted to open the connection between the internal antenna and the wireless modem, and close a connection between the external antenna and the wireless modem, in the second position.

4. The apparatus of claim 1, wherein the connector from the external antenna is adapted to engage at least a portion of the mechanical switching apparatus to change the RF connector switch from the first position to the second position.

5. The apparatus of claim 1, wherein the wireless modem is adapted to operate in a frequency between about 2.4 GHz and about 6 GHz.

6. The apparatus of claim 1, wherein the RF switching connector has a volume defined by a length, a width, and a height, and wherein each of the length, width, and height of the RF switching connector are less than 5 mm.

7. The apparatus of claim 1, wherein the apparatus comprises an external chassis, and wherein the external antenna is removably attachable to the RF connector switch through a pre-defined opening in the external chassis.

8. The apparatus of claim 1, further comprising the external antenna coupled to the RF connector switch.

9. An apparatus comprising:
a first internal antenna;
a second internal antenna;
a wireless modem;
a first radio frequency (RF) connector switch coupled to the wireless modem and the first internal antenna, wherein the first RF connector switch is adapted to receive a connector from a first external antenna, and wherein the first RF connector switch is adapted to:
connect the first internal antenna to the wireless modem in a first position when the connector from the first external antenna is not received by the first RF connector switch; and
connect the first external antenna to the wireless modem in a second position when the connector from the first external antenna is received by the RF connector switch; and
a second RF connector switch coupled to the wireless modem and the second internal antenna, wherein the second RF connector switch is adapted to receive a connector from a second external antenna, and wherein the second RF connector switch is adapted to:
connect the second internal antenna to the wireless modem in a first position when the connector from the second external antenna is not received by the second RF connector switch; and
connect the second external antenna to the wireless modem in a second position when the connector from the second external antenna is received by the RF connector switch.

10. The apparatus of claim 9, wherein the first RF connector switch includes a mechanical switching apparatus that is adapted to:
close a connection between the first internal antenna and the wireless modem in the first position of the first RF connector switch; and
open the connection between the first internal antenna and the wireless modem, and close a connection between the first external antennal and the wireless modem, in the second position of the first RF connector switch.

11. The apparatus of claim 9, wherein the second RF connector switch includes a mechanical switching apparatus that is adapted to:
close a connection between the second internal antenna and the wireless modem in the first position of the second RF connector switch; and
open the connection between the second internal antenna and the wireless modem, and closes a connection between the second external antennal and the wireless modem, in the second position of the second RF connector switch.

12. The apparatus of claim 9, wherein the connector from the first external antenna engages at least a portion of the mechanical switching apparatus to change the first RF connector switch from the first position to the second position.

13. The apparatus of claim 9, wherein the wireless modem is operates in a frequency between about 2.4 GHz and about 6 GHz.

14. The apparatus of claim 9, wherein the first RF switching connector and second RF switching connector each have a respective volume defined by a length, a width, and a height, and wherein each of the length, width, and height of both the first RF switching connector and second RF switching container are less than 5 mm.

15. The apparatus of claim 9, wherein the apparatus comprises an external chassis, and wherein the first external antenna is removably attachable to the first RF connector switch through a first pre-defined opening in the external chassis, and the second external antenna is removably attachable to the second RF connector switch through a second pre-defined opening in the external chassis.

16. The apparatus of claim 9, further comprising the first external antenna coupled to the first RF connector switch.

17. A computer system comprising:
a base comprising a keyboard;
a lid coupled to the base and comprising a display screen;
a first internal antenna coupled to the lid or the base;
a second internal antenna coupled to the lid or the base;
a wireless modem;
a first radio frequency (RF) connector switch coupled to the wireless modem and the first internal antenna, wherein the first RF connector switch is adapted to receive a connector from a first external antenna, and wherein the first RF connector switch is adapted to:
connect the first internal antenna to the wireless modem in a first position when the connector from the first external antenna is not received by the first RF connector switch; and
connect the first external antenna to the wireless modem in a second position when the connector from the first external antenna is received by the RF connector switch; and
a second RF connector switch coupled to the wireless modem and the second internal antenna, wherein the second RF connector switch is adapted to receive a connector from a second external antenna, and wherein the second RF connector switch is adapted to:
connect the second internal antenna to the wireless modem in a first position when the connector from the second external antenna is not received by the second RF connector switch; and
connect the second external antenna to the wireless modem in a second position when the connector from the second external antenna is received by the RF connector switch.

18. The computer system of claim 17, wherein the first RF connector switch includes a mechanical switching apparatus that is adapted to:
close a connection between the first internal antenna and the wireless modem in the first position of the first RF connector switch; and
open the connection between the first internal antenna and the wireless modem, and close a connection between the first external antennal and the wireless modem, in the second position of the first RF connector switch.

19. The computer system of claim 17, wherein the second RF connector switch includes a mechanical switching apparatus that is adapted to:
close a connection between the second internal antenna and the wireless modem in the first position of the second RF connector switch; and
open the connection between the second internal antenna and the wireless modem, and closes a connection between the second external antennal and the wireless modem, in the second position of the second RF connector switch.

20. The computer system of claim 17, wherein the connector from the first external antenna engages at least a portion of the mechanical switching apparatus to change the first RF connector switch from the first position to the second position.

21. The computer system of claim 17, wherein the wireless modem is operates in a frequency between about 2.4 GHz and about 6 GHz.

22. The computer system of claim 17, wherein the first RF switching connector and second RF switching connector each have a respective volume defined by a length, a width, and a height, and wherein each of the length, width, and height of both the first RF switching connector and second RF switching container are less than 5 mm.

23. The computer system of claim 17, wherein the apparatus comprises an external chassis, and wherein the first external antenna is removably attachable to the first RF connector switch through a first pre-defined opening in the external chassis, and the second external antenna is removably attachable to the second RF connector switch through a second pre-defined opening in the external chassis.

24. The computer system of claim 17, further comprising the first external antenna coupled to the first RF connector switch.
